(19) United States
(12) Patent Application Publication
(10) Pub. No.: US 2014/0338545 A1
(43) Pub. Date: Nov. 20, 2014

(54) Grilling Device

(71) Applicant: Saadi Ramadan, Alsip, IL (US)

(72) Inventor: Saadi Ramadan, Alsip, IL (US)

(21) Appl. No.: 14/279,376

(22) Filed: May 16, 2014

Related U.S. Application Data
(60) Provisional application No. 61/824,534, filed on May 17, 2013.

(51) Int. Cl. A47J 37/04

(52) U.S. Cl. CPC A47J 37/049
USPC 99/445

(57) ABSTRACT

A grilling device includes a rod and first and second baskets rotateably attached to the rod. The baskets each define an internal volume and can be rotated to an open position to access the internal volume and to a closed position to prevent access to the internal volume between the baskets. Levers are attached to each basket. A plate slides between the first lever and the second lever to lock the first basket and the second basket in the closed position.

### CROSS-REFERENCE TO RELATED APPLICATIONS

This utility patent application claims priority to U.S. provisional patent application Ser. No. 61/824,534 filed on May 17, 2014, which is incorporated by reference herein.

### TECHNICAL FIELD

The invention relates to grilling devices.

### BACKGROUND

Grilling is a popular method of food preparation. Many people enjoy cooking and eating kabobs and similar types of food that are prepared using skewers. A skewer is a thin metal or wood stick used to hold pieces of food suspended close to a heat source such as hot coals. They are used while grilling or roasting meats, and in other culinary applications.

Metal skewers are typically stainless steel rods with a pointed tip on one end and a grip of some kind on the other end for ease of removing the food. Non-metallic skewers are often made from wood.

When grilling certain types of meat or vegetables on skewers, the meat or vegetable can falloff, crumble, or may even fall into the gaps of a grill. When this happens, the food is discarded. Often, various meats and other food may be grilling at the same time. However, the large gaps of the grill are not very conducive to cooking every item, such as ground beef or small shrimp. This can not only be frustrating and wasteful, but can also be extremely dangerous. Cooks using a grill tend to feel limited while cooking, and are in need of a tool that will expand grilling options.

### SUMMARY

The present invention describes an efficient means of grilling items such as kabobs. The device comprises a series of small baskets mounted on a rod. It permits food to be placed within the baskets and then placed onto a grill. The food will then cook evenly and the device will hold the ground beef or other ingredients together, preventing the food from falling into the cracks of the grill. The rod holds the baskets, and is used as a mechanism for opening and closing, with each basket opening from the middle. When food placed in the basket, levers at the bottom of the rod can be used to open and close the baskets. The present invention provides a neat, efficient way to prepare kabob style food, prevents ground beef from falling apart into a grill, and cooks food evenly and precisely.

In one general aspect, a grilling device includes a rod and first and second baskets rotateably attached to the rod. The first basket and the second basket each define an internal volume such that the first basket and the second basket rotate to an open position to access the internal volume defined by the first basket and the second basket and a closed position to prevent access to the internal volume defined by the first basket and the second basket. First and second levers are attached to first and second basket, respectively. A plate slides between the first lever and the second lever to lock the first basket and the second basket in the closed position.

Embodiments may include one or more of the following features. For example, the first and second baskets may have a first and second rim, respectively, that make contact in the closed position. The first and second baskets may be each made of wire mesh attached to a frame. The baskets may be shaped as a series of oval wire mesh baskets. This can be used to contain different types of food in separate ovals of the basket.

Hinges may be used to attach the first and second baskets to the rod. The hinges may be made of a series of removable rings. Stoppers may also be used to prevent lateral movement of the series of removable rings.

The plate can have first and second cut-outs to receive the first and second rods when the plate slides between the rods.

A handle may be attached to the rod. The handle can be made of wood or other material that does not conduct heat easily.

### DESCRIPTION OF THE DRAWINGS

FIG. 1 shows a perspective view of the grilling device;

FIGS. 2A and 2B show partial views of the grilling device with baskets in closed and open positions, respectively;

FIG. 3 shows a partial view of the grilling device with a plate that slides between levers; and

FIG. 4 shows another perspective view of the grilling device in the open position.

### DETAILED DESCRIPTION OF EMBODIMENTS

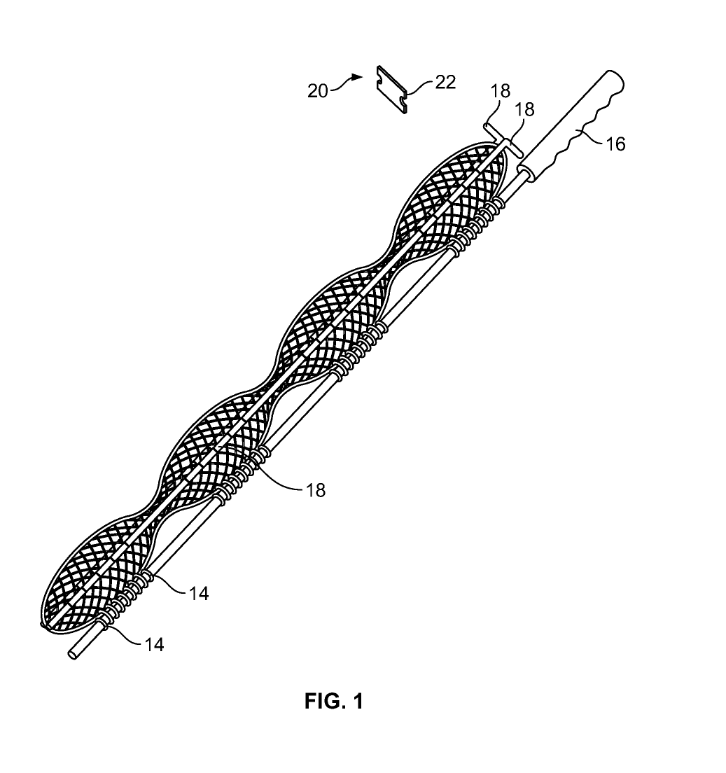

Referring now to FIG. 1, there is shown a diagram of the present invention. The grilling device comprises a set of baskets 10 mounted on a rod 12 by hinges 14. The grilling device is constructed from stainless steel and wood or other suitable materials. In the embodiment shown, the grilling device includes four small, perforated baskets 10 mounted on the rod 12 of the device. The rod 12 is preferably stainless steel with a wooden handle 16.

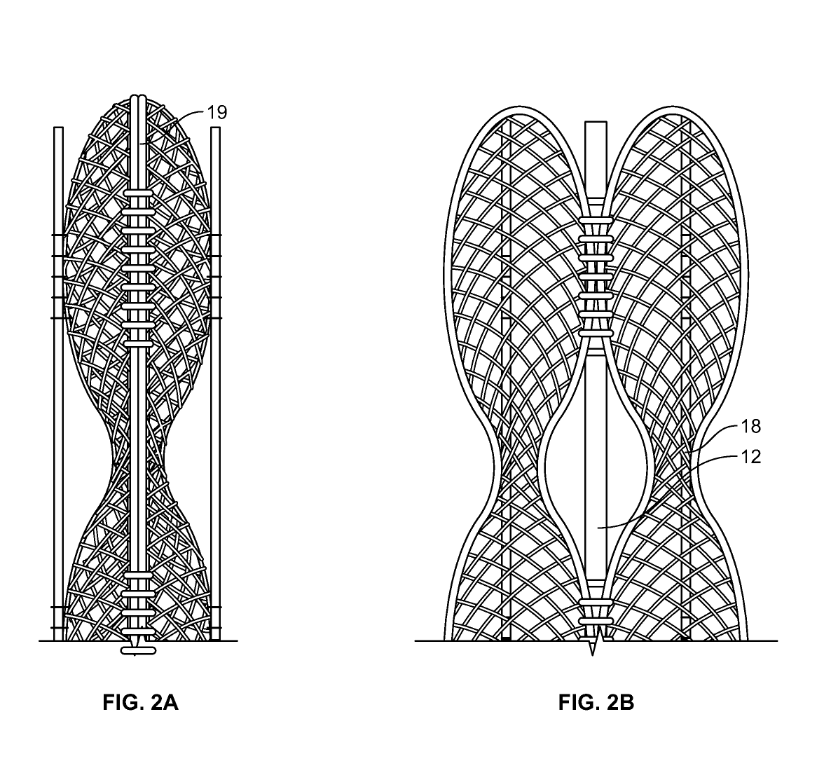

A lever 18 is attached to each set of baskets 10 to open and close the baskets. As shown in FIGS. 2A and 2B, the levers 18 are rotated so that mating surfaces 19 of the baskets 10 close around the food and can be rotated to move the mating surfaces of the baskets 10 away from each other to add or remove food.

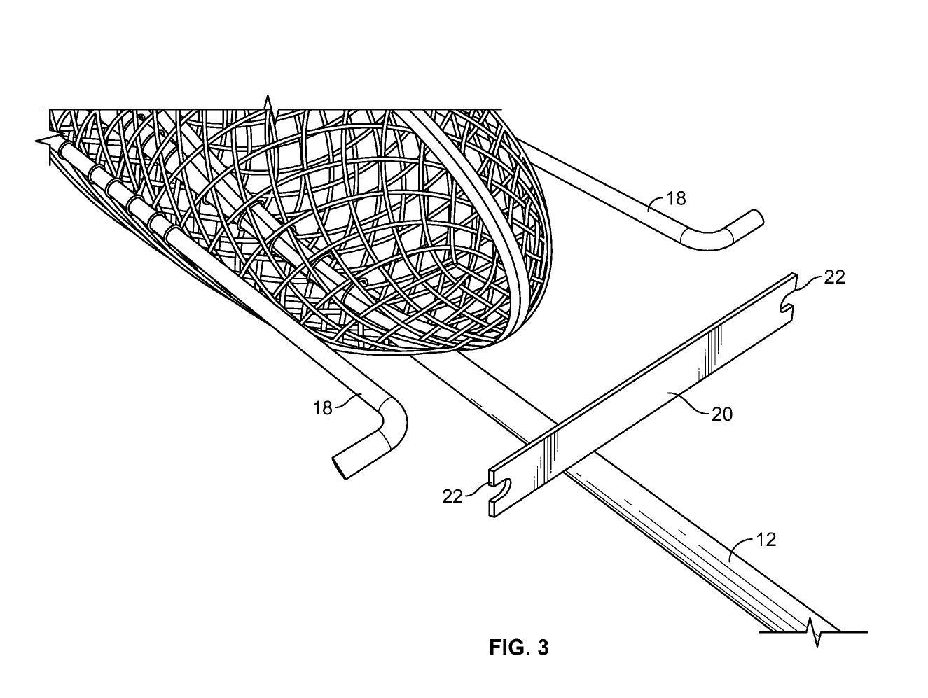

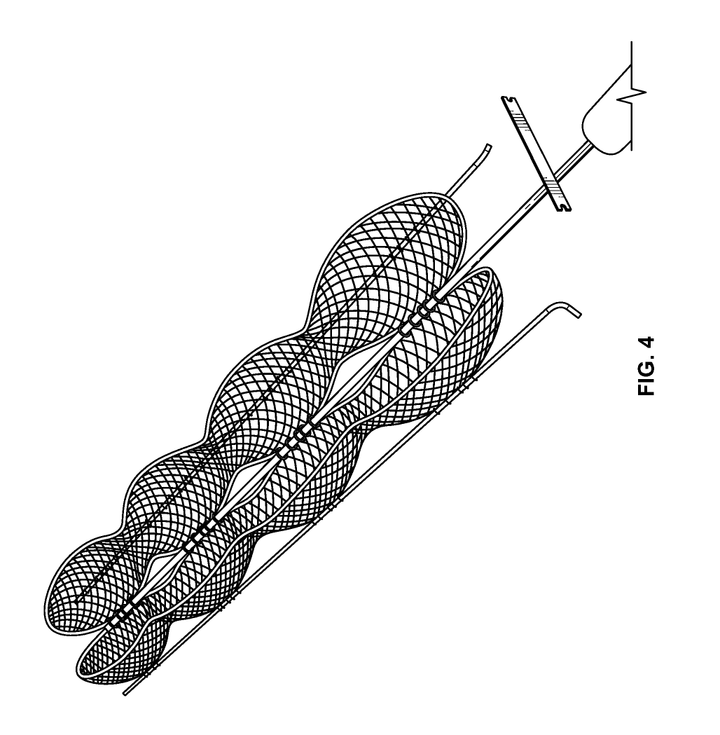

Referring to FIG. 3, when the baskets 10 are rotated to the closed position, a plate 20 can be inserted between the levers 18 to lock the baskets 10 in a closed position. The plate 20 has channels 22 at each end so that the plate 20 slides between the levers 18 to keep the baskets 10 closed. As shown in FIG. 4, once the plate 20 is removed from between the levers 18, the baskets can be opened again.

In one of the embodiments, there are springs attached to the baskets to add pressure to the device in order to permit the baskets to open and close.

The baskets 10 are constructed of wire mesh with openings. The openings between the wire are designed so that heat penetrates evenly in order to cook the food inside the basket 10 according to the user's taste. The baskets are fireproof to enable use on a charcoal or gas powered grill. On the inside, the baskets can be lined with a non-stick component so the meat does not stick, crumble, or burn.

When in use, the device is placed on a charcoal or gas grill. The baskets' design is constructed to preserve the taste of the food and to cook food evenly via the openings in the baskets. The device is easy to use, and most importantly accommodates various food types. The enclosed baskets prevent the meat from falling apart, while also preserving the food and the grill. After grilling, each basket creates a nicely shaped, evenly cooked kabob. The device provides easy access for cleaning, since the baskets open and close, allowing the user to scrub each the apparatus. The present invention can be used by everyone, especially those who enjoy grilling and are seeking more grilling options. In this way, the present invention provides an efficient means of preparing kabobs.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1. A grilling device, comprising:
a rod;
a first basket and a second basket rotateably attached to the rod, wherein
the first basket and the second basket each define an internal volume, and
the first basket and the second basket rotate to an open position to access the internal volume defined by the first basket and the second basket and a closed position to prevent access to the internal volume defined by the first basket and the second basket;
a first lever attached to the first basket and a second lever attached to the second basket; and
a plate to slide between the first lever and the second lever to lock the first basket and the second basket in the closed position.

2. The grilling device of claim 1, wherein the first basket comprises a first rim and the second basket comprises a second rim that make contact in the closed position.

3. The grilling device of claim 1, further comprising a first hinge that rotateably attaches the first basket to the rod and second hinge that rotateably attaches the second basket to the rod.

4. The grilling device of claim 3, wherein the first hinge and the second hinge each comprise a series of removable rings.

5. The grilling device of claim 4, further comprising one or more stopper to prevent lateral movement of the series of removable rings.

6. The grilling device of claim 1, wherein the plate comprises a first and second cut-out to receive the first and second rod when the plate slides between the first and second rod.

7. The grilling device of claim 1, further comprising a handle attached to the rod.

8. The grilling device of claim 1, wherein the first basket comprises wire mesh attached to a first frame and the second basket comprises wire mesh attached to a second frame.

9. The grilling device of claim 1, wherein the first basket and the second basket each comprise a series of oval wire mesh baskets.
